(19) United States
(12) Patent Application Publication
(10) Pub. No.: US 2005/0099382 A1
(43) Pub. Date: May 12, 2005

(54) Device for displaying a browser comprising specific zones

(76) Inventors: Sylvie Bourges, Chanteloup (FR); Benot Guerin, Rennes (FR); William Renault, Cesson Sevigne (FR); Rene Gauthier, Arzon (FR)

Correspondence Address: THOMSON LICENSING INC., PATENT OPERATIONS, PO BOX 5312, PRINCETON, NJ, 08543-5312, US

(21) Appl. No.: 10/466,399

(22) PCT Filed: Jan. 21, 2002
(86) PCT No.: PCT/FR02/00221

(30) Foreign Application Priority Data
Jan. 22, 2001 (FR) 01/00907

(51) Int. Cl. G09G 5/00

(52) U.S. Cl. 345/156

(57) ABSTRACT

The present invention relates to a display device for a browser comprising a means for displaying a status zone, a means for displaying a tool zone, a means for displaying an address entry zone, and a display zone. The device furthermore comprises a means of activating each means of display of the zones by user commands. According to an improvement, the address entry zone disappears when the connection is established, so as to obtain a larger area of display of the image downloaded from the site.

Nowadays, Internet browsers are no longer located solely on computers but also on televisions and digital decoders. Within the framework of an Internet browser on a digital decoder or a television, we shall offer the possibility of best optimizing the zone of display of the HTML page (Internet window) through a user interface dedicated to the world of television. Indeed, the behaviour of the user of a digital decoder or of a television is not the same as that of the user of a computer. He is often further away from his television than from the screen of his computer. Moreover, the definition of a television screen is not as good as that of a computer screen. The user interface of the browser must therefore still offer the same functionalities whilst taking these differences and constraints into account.

Browsers currently offer a menu with a fixed display zone. This zone occupies appreciable space to the detriment of the downloaded information, originating from a network such as the Internet for example.

PC browsers currently offer a menu, a toolbar and an input bar for the URL with a fixed display zone. The object of the present invention is to offer the functionalities that are indispensable for browsing. In addition to these functionalities, the user interface offered allows the user to magnify his window for access to the Internet.

The invention proposes a display device comprising a means for displaying a status zone, a means for displaying a tool zone, a means for displaying an address entry zone, and a display zone, characterized in that it comprises a means of activating each means of display of the zones by user commands.

The present invention allows the user to tailor the elements displayed during the execution of the browser with the aid of a command formulated by the user, these elements disappearing as soon as they are no longer necessary. In this way, the display zone is optimized.

The present invention will now appear with greater detail within the framework of the description which follows of exemplary embodiments given by way of illustration while referring to the appended figures which represent:

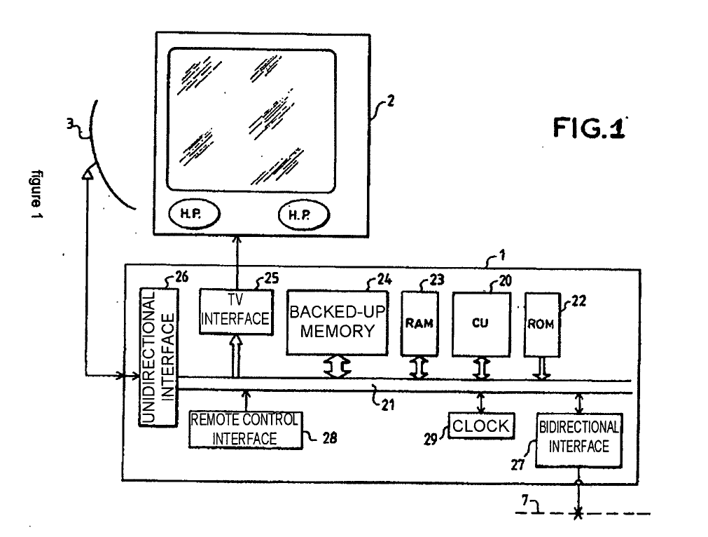

FIG. 1, a diagram of a receiver for the implementation of the invention,

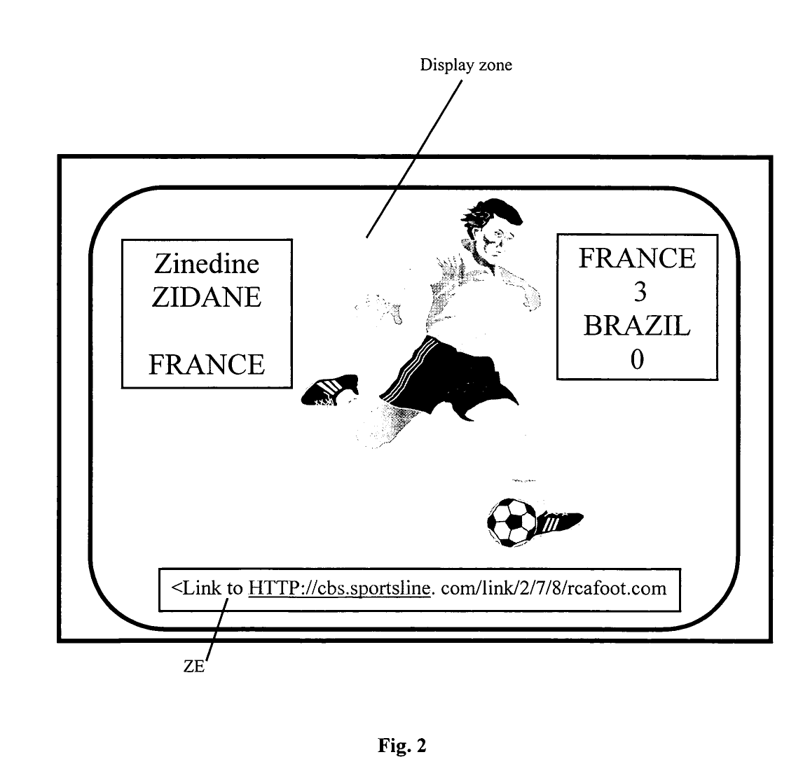

FIG. 2: a screen shot showing the status bar,

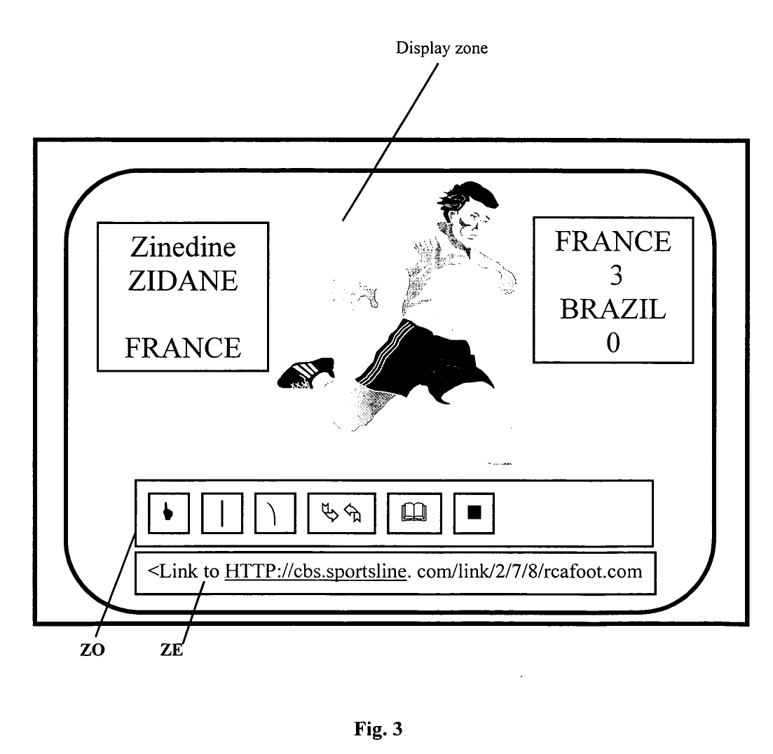

FIG. 3: a screen shot showing the toolbar,

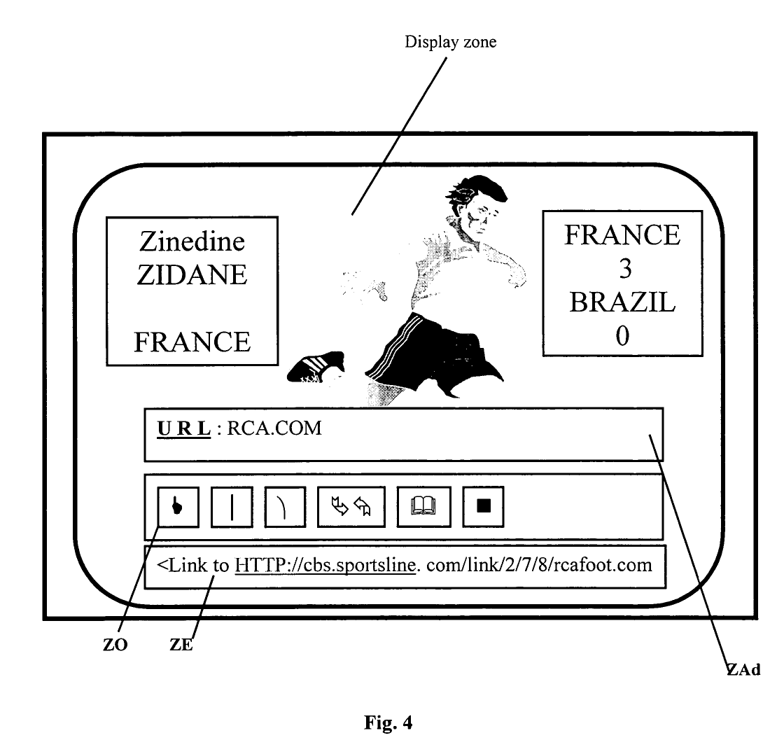

FIG. 4: a screen shot showing the address entry bar.

The diagram of FIG. 1 shows an example of the structure of a digital television receiver 1 according to the invention. The decoder 1 comprises a central unit 20 for example a microprocessor or a custom circuit, connected to the other elements by an internal communication bus 21. The main elements connected to the bus are: a program read only memory 22 containing among other things the program executable on power-up, a RAM type work memory 23, a programmable nonvolatile memory 24 containing data for example, downloaded screen pages and/or executable code, a connector such as a SCART socket 25 for communicating with the television, a unidirectional communication interface 26 for receiving and processing the signals received by the antenna 3, a bidirectional communication interface 27 which is typically a modem linked to the telephone network and which is linked to the return path and an infrared receiver 28 receiving signals from a remote control in a known manner. The communication interface 27 is capable of accessing a network such as the Internet. Upon a connection request, the interface 27 indicates to the central unit 20 whether the connection is or is not effected. A character generator integrated into the TV interface allows the generation of command or graphics menus relating to the parameters of the receiver or to a particular application. This character and graphics menu generator is preferably in the form of software burnt into the read-only memory 22. It may also be embodied in the form of a custom circuit. The video signal generated by this character generator is multiplexed with one of the video signals originating from a video decoder heading for a first SCART socket linked to the television 2.

According to another embodiment, the decoder is integrated into the television, thus allowing it to use certain modules already present, such as the tuner and/or the infrared receiver 28 with its remote control.

We shall now present an exemplary user interface for the implementation of the invention.

The user interface is represented graphically by a zone placed at the bottom of the screen so as not to impede browsing and viewing.

It does not consist of a single block but of the following three independent zones: the status bar, the toolbar, the address entry bar.

As shown in FIG. 2, the status bar ZE presents the user with the status of the connection of his receiver (loading of a page in progress, connection in progress, etc.) and possibly with the activity of the network. According to one embodiment, the status bar is constantly present on the screen. The status bar ZE takes the form of a text zone, containing a text displaying the information useful to the user, and possibly icons representing with the aid of a symbol the activity of the browser.

When the television receiver is connected, the user can make the toolbar ZO appear by pressing a key of the remote control or of the keypad. It disappears when this same key is pressed again. As shown in FIG. 3, the toolbar ZO is a zone of the screen which appears above the status bar. The toolbar preferably contains icons corresponding to functionalities offered to the user.

For this toolbar, only functionalities that are indispensable for browsing will be presented. These functionalities are at one and the same time accessible via the remote control (or the keypad) of the decoder or of the television (shortcut keys) or via the toolbar ZO itself (by moving the focus onto the buttons and by activating the selected button). The list of functionalities hereinbelow is accessible via the remote controls and/or via the toolbar:

“GOTO” ( [symbol] icon): this functionality makes it possible to display the address entry bar, a functionality directly accessible from a key of the remote control or of the keypad.

“BACK” (| icon): this functionality makes it possible to backtrack through the tree of loaded pages, a functionality directly accessible from a key of the remote control or of the keypad.

“FORWARD” ( [symbol] icon): this functionality makes it possible to track forward through the tree of loaded pages, a functionality directly accessible from a key of the remote control or of the keypad.

“REFRESH” ( [symbol] icon): this functionality makes it possible to reload the current page, a functionality that is currently not accessible from a key of the remote control or of the keypad, but it could become so in future products.

“HOME” ( [symbol] icon): this functionality makes it possible to display the page of the customer, a functionality that is currently not accessible from a key of the remote control or of the keypad, but it could become so in future products.

“STOP” (▪ icon): this functionality makes it possible to halt the loading of a page, a functionality directly accessible from a key of the remote control or of the keypad.

According to an improvement, the customer can always add new functionalities via a button in the toolbar in such a way as not to increase the space taken by the user interface to the detriment of the display dedicated to the information originating from the Internet.

As shown by FIG. 4, the bar for entering the address ZAd allows the user to enter the precise label of the address of the site to which the user wishes to connect. In the world of the Internet, this address is called a URL (standing for “Universal Resource Locator”). The address entry bar appears above the toolbar, by clicking on a button of the toolbar (GOTO functionality described above) or a dedicated key of the remote control or of the keypad. In this way, the address entry bar is displayed in place of a part of the display zone situated at the bottom. The upper part of the display zone is not masked, only the lower part which generally contains less important information is masked. The bar disappears automatically as soon as the address is taken into account by the browser for the loading thereof. This disappearance makes it possible to increase the useful display space for the data downloaded from the Internet. It is in fact unnecessary to let it display since the information originating from the connection site informs the user of the identity thereof. If the connection did not go well, the bar disappears also. The user is aware of the connection failure through the fact that no information relating to the site appears, the content of the display zone remains unchanged.

1. Display device comprising a means for displaying a status zone, a means for displaying a tool zone, a means for displaying an address entry zone, and a means of display of a display zone, a means of activating each means of display of the zones by user commands; wherein it furthermore comprises a means of connection with the site whose address is entered into the zone, the said means activating the disappearance of the address zone at the end of the connection request.

2. Device according to claim 1, wherein the status zone, the tool zone and the address entry zone appear successively from the bottom of the display zone, in such a way that the top part of the display zone is not masked.

3. Device according to claim 1, wherein the said means of connection allowing the display of the graphics page downloaded from the said address should the connection be established.

4. Device according to claim 2, wherein the said means of connection allowing the display of the graphics page downloaded from the said address should the connection be established.

5. Device according to claim 3, wherein the said means of connection leaves the content of the display zone unchanged when the connection could not be established.

6. Device according to claim 4, wherein the said means of connection leaves the content of the display zone unchanged when the connection could not be established.

7. Device according to claim 1, wherein the tool zone comprises at least one icon for activating the means for displaying the address zone of the network, the address then being entered with the aid of a keypad.

8. Device according to claim 1, wherein it comprises at least one icon for stopping a connection for loading a page to be displayed into the useful zone.
